(19) United States
(12) Patent Application Publication
(10) Pub. No.: US 2025/0355892 A1
(43) Pub. Date: Nov. 20, 2025

(54) METHODS AND SYSTEMS FOR ENCODING STRUCTURED DATA TO IMPROVE LATENCY WHEN USING LARGE LANGUAGE MODELS

(71) Applicant: Shopify Inc., Ottawa (CA)

(72) Inventors: Matthew Colyer, Redwood City, CA (US); Daniel Beauchamp, Ottawa (CA)

(21) Appl. No.: 18/663,721

(22) Filed: May 14, 2024

(51) Int. Cl. G06F 16/25

(52) U.S. Cl. CPC G06F 16/258

(57) ABSTRACT

A computer method for encoding structured data, the encoding comprising substituting one or more data elements within the structured data with corresponding one or more aliases, thereby producing encoded structured data, wherein the corresponding one or more aliases have a shorter tokenized representation than the one or more data elements; providing the encoded structured data to a Large Language Model (LLM); receiving an output from the LLM; and decoding the output to substitute the corresponding one or more aliases with the one or more data elements.

### FIELD OF THE DISCLOSURE

The present disclosure is related to large language models (LLMs), and in particular relates to large language models and structured data.

### BACKGROUND

Large Language Models (LLMs) may be used as assistants in the processing and manipulation of structured data. For example, such structured data may include a website, a theme for a webpage, or other such information. However, other options for structured data that may be provided as a token to an LLM are also possible.

### SUMMARY

In accordance with the embodiments of the present disclosure, structured data may not be particularly suitable for an LLM. Long text segments such as identifiers in the structured data may introduce latency and/or errors in LLM processing. Specifically, longer identifiers mean more tokens to be input to the LLM, which translates to more resources needed at the LLM. Generally, in LLMs, input is provided in a token-at-a-time manner, and there exists a processing cost to providing a token as input and then updating the state of the LLM for that input. Thus, with fewer tokens there are fewer inputs, leading to less computational resources.

Thus, for structured data with long, textually verbose data elements, the present disclosure comprises an encoding module for parsing the structured data document and replacing verbose elements with shorter, token-efficient elements or aliases. In one case, such verbose elements may include key-value pairs having textually dense identifiers, and the token elements may be significantly simplified key-value pairs. In other cases, repeated elements with significant detail may be simplified by replacing such elements with less verbose structures.

The LLM can then use such output from the encoding module to generate its output, which can then be converted back to the verbose form using a decoding module.

Therefore, in one aspect, a computer-implemented method may be provided. The method may include encoding structured data, the encoding comprising substituting one or more data elements within the structured data with corresponding one or more aliases, thereby producing encoded structured data, wherein the corresponding one or more aliases have a shorter tokenized representation than the one or more data elements. The method may further include providing the encoded structured data to the LLM and receiving an output from the LLM. The method may further include decoding the output to substitute the corresponding one or more aliases with the one or more data elements.

In some embodiments, the encoding may create a mapping between the one or more data elements and the one or more aliases, wherein the decoding using the mapping to substitute the corresponding one or more aliases with the one or more data elements.

In some embodiments, the mapping may use at least one of a database and a look-up table.

In some embodiments, the mapping may be static during a session with the LLM.

In some embodiments, the one or more data elements may comprise element identifiers within the structured data.

In some embodiments, the corresponding one or more aliases may be sequentially numbered.

In some embodiments, the one or more data elements may comprise variables within the structured data.

In some embodiments, the computing device may be one of a client device and a server device.

In a further aspect, a computing device having a processor, a memory, and a communications subsystem may be provided. The computing device may be configured to encode structured data by substituting one or more data elements within the structured data with corresponding one or more aliases, thereby producing encoded structured data, wherein the corresponding one or more aliases have a shorter tokenized representation than the one or more data elements. The computing device may be further configured to provide the encoded structured data to the LLM and receive an output from the LLM. The computing device may further be configured to decode the output to substitute the corresponding one or more aliases with the one or more data elements.

In some embodiments, the computing device may be configured to encode by creating a mapping between the one or more data elements and the one or more aliases. The computing device may further be configured to decode by using the mapping to substitute the corresponding one or more aliases with the one or more data elements.

In some embodiments, the mapping may use at least one of a database and a look-up table.

In some embodiments, the mapping may be static during a session with the LLM.

In some embodiments, the one or more data elements may comprise element identifiers within the structured data.

In some embodiments the corresponding one or more aliases may be sequentially numbered.

In some embodiments, the one or more data elements may comprise variables within the structured data.

In some embodiments, the computing device may be one of a client device and a server device.

In a further aspect, a non-transitory computer readable medium may be provided. The non-transitory computer readable medium being configured for storing instruction code that, when processed by a processor of a computing device, may cause the computing device to encode structured data by substituting one or more data elements within the structured data with corresponding one or more aliases, thereby producing encoded structured data, wherein the corresponding one or more aliases have a shorter tokenized representation than the one or more data elements. The instruction code, when processed by a processor of a computing device, may further cause the computing device to provide the encoded structured data to the LLM and receive an output from the LLM. The instruction code, when processed by a processor of a computing device, may further cause the computing device to decode the output to substitute the corresponding one or more aliases with the one or more data elements.

In some embodiments, the instruction code may be configured to cause the computing device to encode by creating a mapping between the one or more data elements and the one or more aliases; and decode by using the mapping to substitute the corresponding one or more aliases with the one or more data elements.

In some embodiments, the mapping may use at least one of a database and a look-up table.

In some embodiments, the mapping may be static during a session with the LLM.

### BRIEF DESCRIPTION OF THE DRAWINGS

The present disclosure will be better understood with reference to the drawings, in which:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3 is a block diagram showing an example layout for a web page including sections and blocks.

FIG. 4 is a block diagram showing an example web page with an artificial intelligence assistant providing the ability to manipulate the web page.

FIG. 5 is a process diagram showing a process for encoding data elements into aliases.

FIG. 6 is a process diagram showing a process for decoding aliases to data elements.

FIG. 7 is a dataflow diagram showing the encoding and decoding of structured data at a client computing device.

FIG. 8 is a dataflow diagram showing the encoding and decoding of structured data at a server computing device.

FIG. 9 is a dataflow diagram showing the encoding and decoding of structured data at an LLM client computing device.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

Structured data may not be particularly suitable for input to an LLM. As used herein, structured data refers to data that is a standardized format that may make it accessible to humans and/or computing devices. Typically, such data uses a data model to organize elements of data and define how they relate to one another. Examples may include webpages, which may use HyperText Markup Language (HTML) tags to describe elements of the webpages. Another example may be the use of Structured Query Language (SQL) databases, for example for data management. Another example may be the data used to train machine learning algorithms, which, when labeled may be part of supervised learning. In some cases, such structured data may be part of key-value pairs.

For example, a Software as a Service (SaaS) platform such as one offering website hosting services may allow users the ability to converse with an Artificial Intelligence (AI) powered assistant. In some cases, the user may, among other possible actions, ask the AI assistant to make a change to the appearance of the website theme. To make relevant changes, the assistant may be supplied with the current state of the page detailing the layout of distinct sections of the page. This information may be stored in the form of a large text file in which individual sections may be represented as hierarchically structured segments of key-value pairs, where in some cases the values are particularly lengthy unique identifiers.

This poses a number of problems. In the case of assistants powered by a large language model, understanding the layout of the page requires that the model processes this structured text by computing complex matrix operations on each token. Therefore, the more textually dense the document is, the greater the computational overhead and time required to generate an output. Furthermore, it is known that language models produce less accurate output when the amount of irrelevant contextual information in the prompt is greater.

In other examples, other structured data may similarly be textually dense.

With this in mind, having a more verbose document can increase the tendency of the model to produce errant output (hallucinations). Further, such textually dense document may increase latency experienced by the user, as described above. Specifically, the long identifiers create multiple tokens, which need to be pumped into the LLM one by one.

Further, in some cases the language model may be used to generate output that when parsed by a rendering layer is presented in the form of actionable User Interface (UI) components. For example, the user may ask the assistant to add a descriptive text section to describe a gallery of images, to which the assistant may respond by generating code required to make this change as well as output that may be rendered in the form of a UI component summarizing the changes to be made, containing a confirmation button to apply the change. In this case the background action would need to specify the identifier of the section, which requires the LLM to generate the section id reference in its output. Generating the executable background actions and the user visible UI renderable output can be time consuming on its own, but may be further exacerbated when the document detailing the page layout is more character-laden, leading the user to experience greater delays between inputting a message to the assistant and receiving a response.

To overcome this, the present disclosure comprises an encoding module for parsing the structured data document and replacing verbose elements with shorter, token-efficient elements or aliases. In one case, such verbose elements may include key-value pairs having textually dense identifiers, and the token elements may be significantly simplified key-value pairs. In other cases, repeated elements with significant detail may be simplified by replacing such elements with less verbose structures. For example, bulky identifiers may be replaced with concise tokens such as $id0, $id1, and $id2, and the verbose data in data types such as ‘newsletter’ may be abbreviated to ‘nl’. Other options are possible.

The LLM can then use such output from the encoding module to generate its output. For example, instead of the verbose identifier, the LLM may output an instruction for $id0.

This output can then, in some cases, be converted back to the bulky identifier prior to being used the make the change to the webpage (or other structured data).

### Machine Learning and Computing Device

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

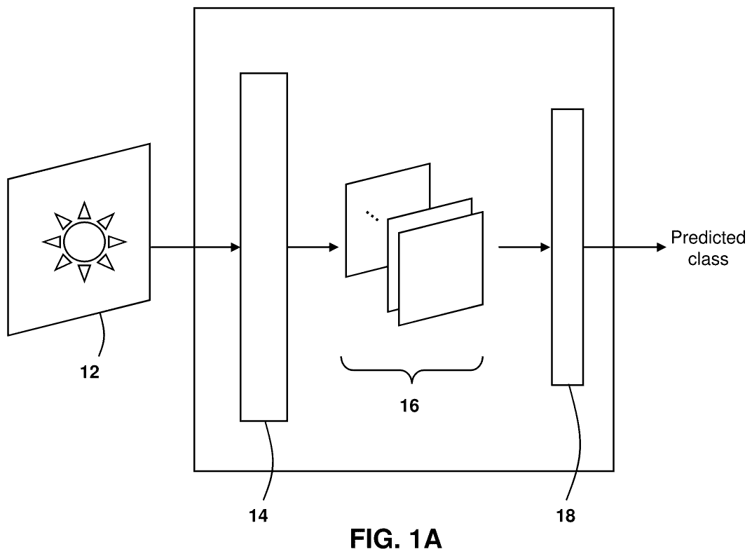

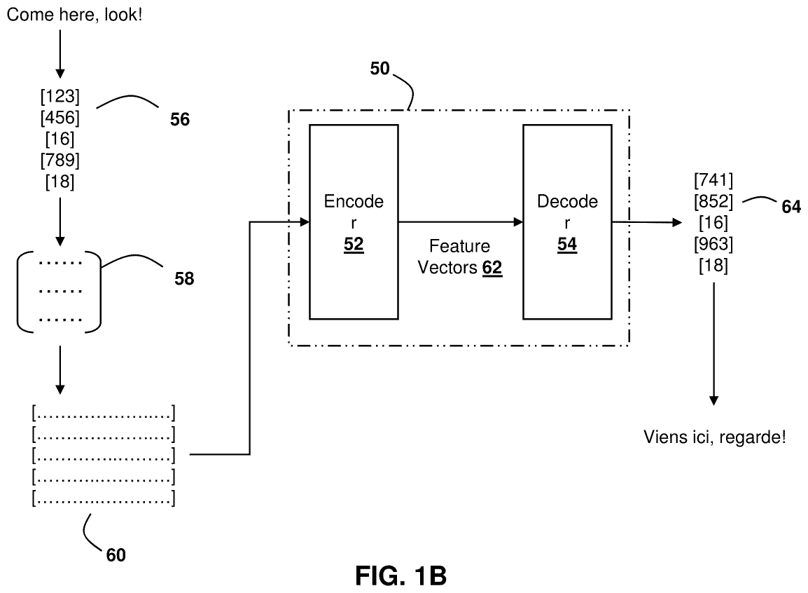

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), an End Of Text [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

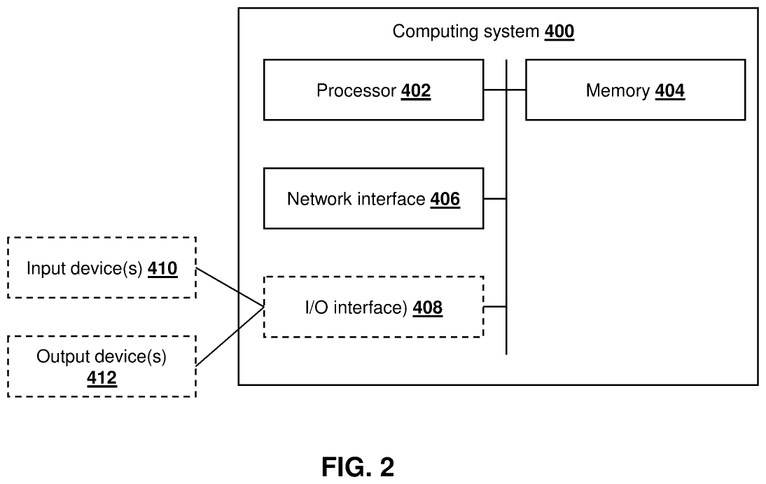

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a Person to Person (P2P) network, a Wide Area Network (WAN) and/or a Local Area Network (LAN)). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Token Encoding/Decoding

When interacting with large language model chat bots, the use of poor token efficiency in structured data can lead to increased latency, higher processing requirements, and incorrect results. Thus, according to the embodiments of the present disclosure, an encoding module is provided which may create more token efficient data to be input to an LLM. Similarly, a decoding module is provided to take results received from an LLM and convert such results into a form usable with structured data.

In the examples below, the structured data is provided as HTML or web page encoding. However, the use of web pages as the structured data input to an encoder is merely provided for illustration and is not limiting. The present disclosure could equally be used with any form of structured data.

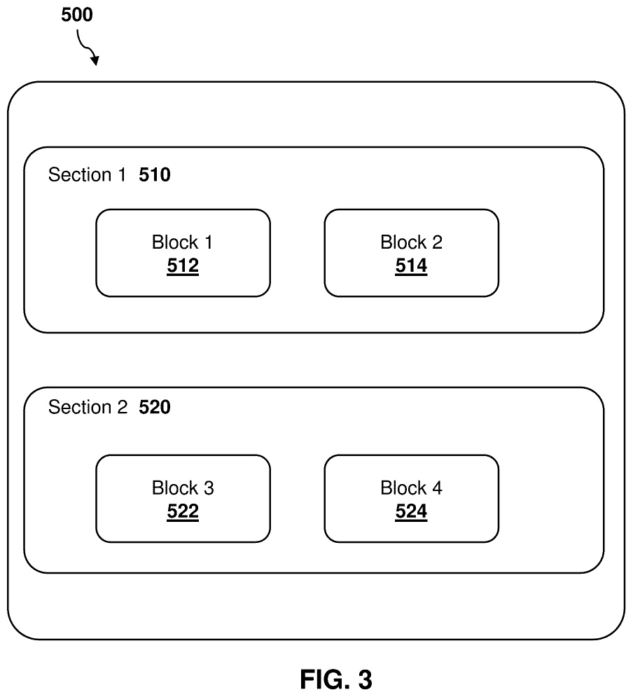

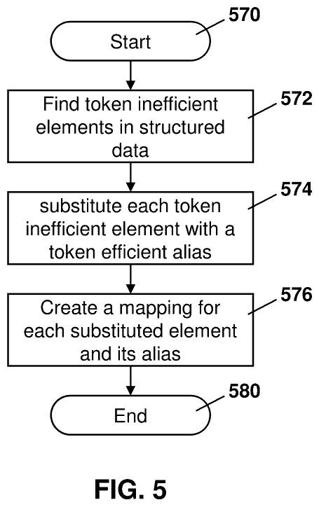

Reference is now made to FIG. 3. In the example of FIG. 3, a simplified web page 500 is shown. In the simplified web page, various sections, namely sections 510 and 520 are provided. As will be appreciated by those in the art, a web page 500 could have a plurality of sections or blocks, and the example of FIG. 5 is merely provided for illustration. For example, each of sections 510 and 520 could be a container for holding elements within the web page, and could have various themes including fonts, backgrounds, spacing, margins, among other factors.

In the example of FIG. 5, section 510 includes various elements or blocks, shown as block 512 and block 514 in this case. Similarly, section 520 includes block 522 and block 524. Again, the use of two blocks within each section is provided merely for illustration, and in practice each section can have more or fewer elements.

In general, each section could have an identifier and data associated therewith. This may represent the current state of the page, detailing the layout of distinct sections of the page. For example, this may include the position of images, text blocks, buttons, widgets, among other information. This information may be stored in the form of a large text file in which individual sections may be represented as hierarchically structured segments of key-value pairs, where in some cases the values are particularly lengthy unique identifiers. Table 1 below provides an example definition for elements of section 510.

TABLE 1
Example of an Individual Section or Block

```
id: 23490sd9fa09ifhfhyyewusuuaq290349293040924
  type: featured-collection
  settings:
    collection: snowboards
    color_scheme: background-1
    columns_desktop: 4
    columns_mobile: ‘2’
    description: ‘’
    description_style: body
    enable_desktop_slider: false
    enable_quick_add: false
    full_width: false
    heading_size: h1
    image_ratio: adapt
    image_shape: default
    padding_bottom: 56
    padding_top: 56
    products_to_show: 8
    show_description: false
    show_rating: false
    show_secondary_image: true
    show_vendor: false
    show_view_all: true
    swipe_on_mobile: false
    title: Bestsellers
    view_all_style: solid
```

However, when using data, such as that described above with regard to Table 1, with an LLM or other Artificial Intelligence (AI) assistant, can cause issues. In the case of assistants powered by a large language model, understanding the layout of the page requires that the model processes this structured text by computing complex matrix operations on each token. Therefore, the more textually dense the document is, the greater the computational overhead and time required to generate an output. Furthermore, having a more verbose document can increase the tendency of the model to produce errant output. Further, the latency experienced by the user and computational overhead is increased with such textually dense input.

For example, the user may ask the assistant to add a descriptive text section to describe a gallery of images, to which the assistant may respond by generating code required to make this change as well as output that may be rendered in the form of a UI component summarizing the changes to be made. In some cases such output may contain a confirmation button to apply the change i.e ‘Apply’. In this case the background action would need to specify the identifier of the section i.e ‘id: 23490sd9fa09ifhfhyyewusuuaq290349293040924’, which requires the LLM to generate the section id reference in its output.

Generating the executable background actions and the user visible UI renderable output can be time consuming on its own but further exacerbated when the document detailing the page layout is more character-laden, leading the user to experience greater delays between inputting a message to the assistant and receiving a response.

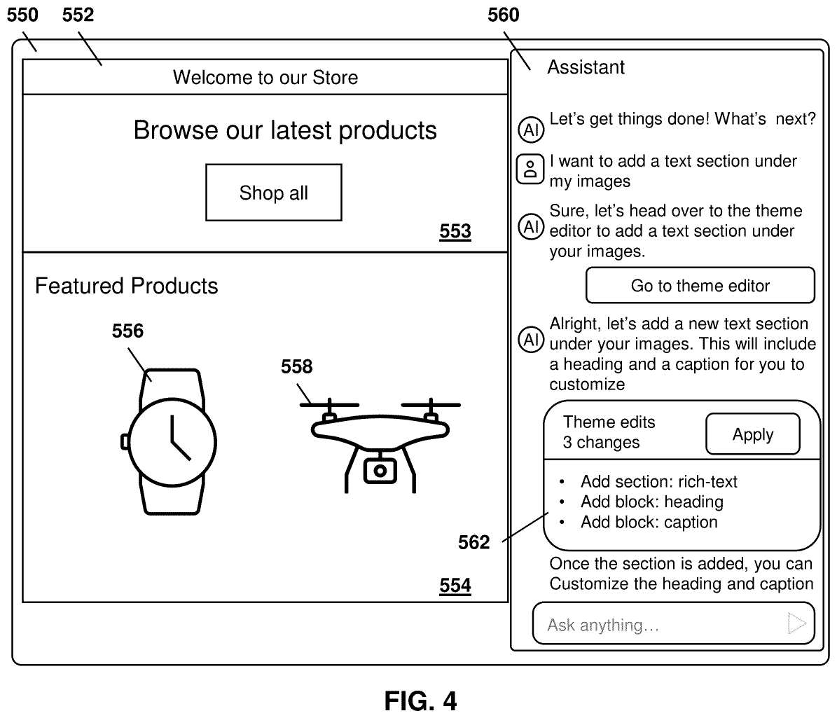

For example, reference is now made to FIG. 4, which shows a web page 550 that is being edited on a computing device with the help of an AI assistant 560. The web page in this case may include sections 552, 553 and 554. Section 554 may display images 556 and 558.

In the example of FIG. 4, a user asks the AI assistant to add text under the images, at which point the AI assistant provides a link to a theme editor. The AI assistant can then indicate that to add images, headings and captions may be added to the web page. A theme edits suggestion box 562 in some cases may be created and allow the user to verify that they want to proceed with such theme edits.

In order for the AI assistant to be able to add sections to the webpage, details of the section, such as those provided in Table 1 above, may need to be inserted into the LLM in the background. This is done by tokenizing the elements of Table 1 and inputting them to the LLM on a token by token basis.

In some cases, multiple sections may need to be input to the LLM in the background. For example, in one simplified case, various verbose elements may be provided to the LLM, as shown with Table 2.

TABLE 2
Example of verbose data elements

id: awjerkj23k4j23lk2j5lk2j5lk235
type: newsletter
id: 23490sd9fa09i290349293040924
type: newsletter
id: jk234jk234klk234j23lkj523l5
type: newsletter

In the example of Table 2, the identifies may all be unique, but to accomplish this they may be long and thus create multiple tokens during tokenization.

Similarly, other data elements within the code may be dense for tokenization, and may in some cases be repeated multiple times. For example, in Table 2, the various data elements all have a type “newsletter”. Spelling out such type for the LLM may again be inefficient from a computational perspective, leading to latency, use of more computational resources, and potentially errors (hallucinations).

Therefore, in accordance with the embodiments of the present disclosure, the input may be provided to an encoding module prior to being input to the LLM. Reference is now made to FIG. 5.

The example of FIG. 5 shows a process at an encoding module. As described below, such encoding module may be at a client side or on the server side. The process of FIG. 5 starts at block 570 and proceeds to block 572 in which the encoding module may find token inefficient elements within the structured data. As used herein, token inefficient elements may indicate elements that are dense and would therefore result in multiple tokens or use more computational resources to create such tokens.

In some cases, the process at block 572 may look for elements for a particular structured data type and therefore the encoding module may be optimized for such structured data type. For example, when processing web page information, the process of block 572 may look for identifier elements, which may be inherently token inefficient.

Further, in some cases the process at block 572 may look for data type definitions which are textually dense, data variables that are textually dense, among other such information. This may in some cases involve a density threshold that, if exceeded, may cause the element to be identified at block 572. However, other options are possible. For example, such density threshold in some cases may be any element that would result in more than one token during tokenization. However, other options are possible.

In some cases, the process at block 572 may find data elements even if they are under a threshold for density if they are of a certain type. For example, as discussed below, it may be beneficial to have identifiers for sections and elements to be provided sequentially in order to allow the LLM to create new sections or elements more efficiently.

For each of the elements of the structured data identified at block 572, the process may proceed to block 574 and substitute such element with an alias. For example, from Table 1 above, the identifier of the section i.e ‘id: 3490sd9fa09ifhfhyyewusuuaq290349293040924’, may be identified at block 572 and at block 574 such identifier may be substituted with an alias ‘id$0’ or ‘$id0’, among other options. The specific syntax of the alias could be chosen by those designing such encoder, and is not limited to any particular syntax.

Similarly, the elements of Table 2 could be provided to the encoder and at block 572 the identifiers, along with the data type definition ‘newsletter’ could be identified. The identifiers could then be sequentially numbered within aliases, and the definition ‘newsletter’ could be shortened to ‘nl’ in one example. This would produce the encoded structured data of Table 3 below.

TABLE 4
Example of Encoded Structured Data

id: $id0
type: nl
id: $id1
type: nl
id: $id2
type: nl

### Sequential Numbering

In some cases, the substitution at block 574 could number the aliases sequentially. For example, on a web page the ordering of the identifiers may be important, and the use of sequential numbering may provide an indication of the location of such element.

Further, LLMs may be poor at creating unique identifiers. However, LLMs are generally good at creating sequential lists. Therefore, if the action that the user requested requires the creation of a new identifier, for example to include a new section or block, the LLM is more likely to be able to create a new identifier in a sequence than a unique identifier.

Thus, for example, if aliases $id0, $id1 and $id3 are provided to the LLM, such LLM, when creating a new section or element, could create the alias $id4 more easily than creating a unique identifier for the new section. Further, when using such created identifier multiple times in the output, the use of the sequential identifier rather than a created identifier could lead to less errors or hallucinations.

Therefore, in one embodiment, the substituting at block 574 could create sequential aliases in the structured data when appropriate. However, such sequential aliases are optional in some cases.

### Mapping

From block 574, the process proceeds to block 576 in which a mapping may be created for each substituted element and its alias. For example, such mapping may be a look up table, database, or other data storage mechanism in which an association between the alias and the data element may be maintained.

The mapping may be stored at the same computing device as the encoding module in some cases. However, in other cases, the mapping may be stored at a different computing device.

### Static Mapping

In some cases, the aliases created at block 574 may be static throughout the session that the user has with the LLM. In particular, LLMs are generally stateless, meaning that they do not remember previous questions and answers. In order to make the LLM more stateful, in some cases the script of the questions previously asked to the LLM and the answers provided by the LLM may be provided in the input to the LLM for subsequent questions.

However, if a user moved sections of the web page around, then the sequential identifiers prior to the moving of such elements and after the moving of such elements may be encoded with different aliases at block 574. For example, if the user asked that section 2 be moved above section 1 in a first question, then section 1 may have had an alias of $id0 and section 2 may have had an alias of $id1.

Then, if the user asks that text be added to section 2, the encoding module at block 574 may see that section 2 is on top, and thus encode its alias as $id0.

However, in this case $id0 is inconsistent between the first encoding and the second encoding. If the history of the conversation is provided to the LLM for subsequent questions, the inconsistency for $id0 may lead to issues.

Therefore, in one embodiment, the substituting at block 574 may first look at the mapping table or database to see if such element has previously been mapped to an alias. If yes, the substituting at block 574 may use the previous alias to create consistency in the session with the LLM.

However, such static mapping is optional.

Once the mapping is completed at block 576, the process proceeds to block 580 and ends.

The result of the process of FIG. 5 is that the encoding module has created the encoded structured data, which may then be provided to the LLM.

### LLM

The encoded structured data can then be provided to the LLM for processing. The LLM can then generate output based on this translated page layout information, resulting in a quicker response. For example, instead of needing to output executable code like ‘insertSectionAfter id jk234jk234klk234j23lkj52315’, the LLM would instead output ‘insertSectionAfter $id2’.

As will be appreciated by those in the art, for the LLM, effectively input is token-at-a-time and there is a certain cost to providing a token as input and then updating the state of the LLM for that input. Thus, fewer tokens equate to fewer inputs which results less computation resources. In the embodiments described herein, the encoding module could easily use the central processing unit (CPU) of the computing device running the encoding module, rather than the more scarce and computationally expensive Graphics Processing Unit (GPU) typically used by LLMs.

This process can significantly reduce the textual density of the document. Reducing the textual density, and in particular the number of tokens in the document, can lead to a more efficient AI assistant performance (e.g., due to a reduced number of tokens that have to be processed in order to process the document).

The LLM therefore produces an output, where such output uses the aliases from the encoding module.

### Decoding

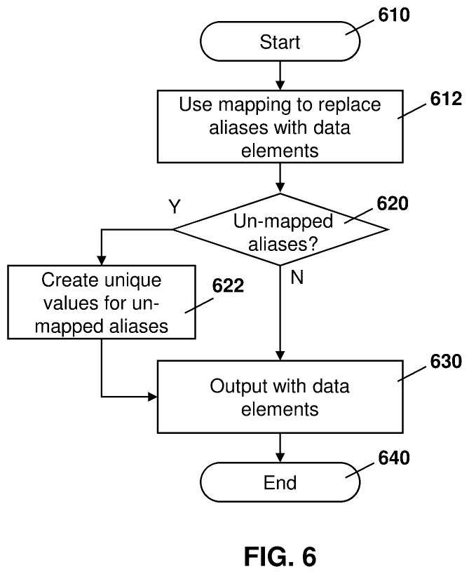

Once the LLM provides an output, this output can then be provided to a decoding module. Specifically, the decoding module may be used to replace aliases in the structured data with the data elements that the aliases replaced. Reference is now made to FIG. 6.

The embodiment of FIG. 6 starts at block 610 and proceeds to block 612 in which the decoding module uses the mapping that was established during the encoding to replace the aliases with data elements. As indicated above, the mapping may use a database, look up table or other data storage mechanism, and may be co-located with the decoding module or maybe on a separate computing device.

In some cases, at block 612 the decoding module may scan the encoded structured data to look for aliases.

In some cases, the aliases may be in a particular form and this form may help to identify the aliases. For example, all the aliases may begin with a ‘$’ in some cases. In this case, the encoding module may have replaced data elements that have the same form during the substitution at block 574, even if such data elements may not have met a threshold density.

In some cases, the aliases may be at certain location or after other elements. For example, when using key-value pairs, the term ‘identifier:’ may indicate that the data after the colon in an alias.

In some cases, the mapping may simply use a find and replace for all alias elements.

Other options are possible.

From block 612, the process proceeds to block 620 in which a check is made to determine whether any alias is found within the encoded structured data does not match the mapping table. This may for example, indicate that new aliases were created by the LLM.

If unmapped aliases are found, the process proceeds to block 622 in which unique values may be created for the unmapped aliases. This may involve finding universally unique identifiers, using random generators to create unique identifiers, using values with timestamps, among other techniques. These new unique identifiers can then be substituted for the alias in the encoded structured data.

From block 620, if no unmapped aliases existed, or from block 622, the process proceeds to block 620 which provides the output from the decoding module as a structured data element that can be used by the original user. For example, such use may be to render a modified website in some embodiments.

From block 630, the process proceeds to block 640 and ends.

As with the encoding module, the decoding module could easily use the central processing unit (CPU) of the computing device running the decoding module, rather than the more scarce and computationally expensive Graphics Processing Unit (GPU) typically used by LLMs.

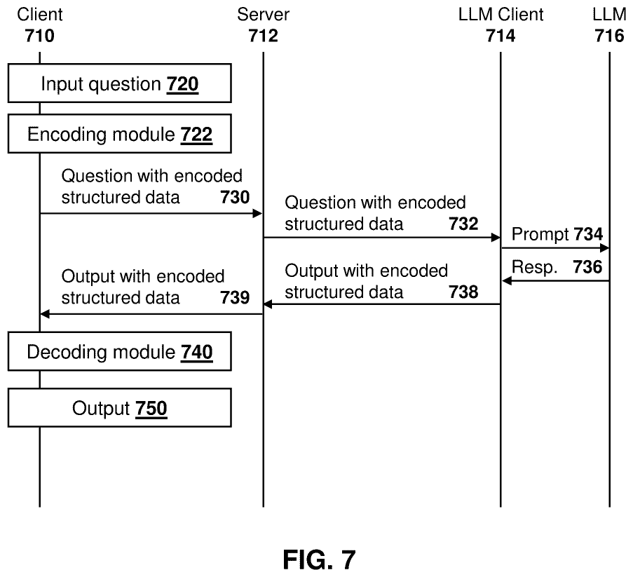

As described above, the encoding and decoding modules can be on any computing device, whether client side or server side. Examples of the encoding and decoding at the client side, server side, and LLM client side are provided in FIGS. 7, 8 and 9 below.

### Encoding and Decoding on a Client Device

Reference is now made to FIG. 7, which shows the encoding and decoding modules at a client 710. For example, client 710 may be a personal computer, tablet, smartphone, laptop, or other computer used by a client. In the situation where the structured data is a web page, client 710 may be a web client.

Client 710 may communicate with a server 712. For example, server 712 may be a web server in some cases. However, in other cases, server 712 may be a corporate server, a cloud server to provide services, among other options.

Further, in some cases server 712 is optional and may not be part of the system. In this case, client 710 may communicate directly with an LLM client 714. Otherwise, server 712 may communicate with LLM client 714.

LLM client 714 is a piece of software directly making the calls to the LLM 716. Specifically, typically an LLM 716 will not be reachable except though an LLM client 714.

However, if the LLM 716 is directly reachable, then LLM client 714 is optional.

In the example of FIG. 7, a user may use client 710, for example using a user interface, to input a question at block 720.

In this case, an encoding module 722 is part of client 710 and can be configured to intercept questions for an AI assistant. In this regard, encoding module 722 may use the process of FIG. 5 to encode the structured data into encoded structured data. For example, long identifiers or data values may be replaced by aliases that are more token friendly than the original data elements.

The client 710 may then forward the question with the encoded structured data in message 730 to server 712. Server 712 may then forward the question with the encoded structured data in message 732 to the LLM client 714. If server 712 is not part of the system, message 730 may proceed directly from the client 710 to the LLM client 714.

LLM client 714 may receive message 732 (or message 730) and may then create a prompt 734 to send to the LLM 716.

LLM 716 processes the question and the data in the prompt, and provides a response 736 back to the LLM client 714.

LLM client 714 may then provide the output with the encoded structured data back to the server 712 in message 738.

Server 712 may provide the output with the encoded structured data back to the client 710 in message 739.

As will be appreciated by those skilled in the art, if server 712 is not part of the system, then the LLM client 714 may send message 738 directly to client 710.

Client 710, upon receiving message 739 (or message 738) may provide the message to the decoding module 740. The decoding module 740 may use the process of FIG. 6 to substitute the aliases with data elements to create structured data.

Such structured data that may then be provided to an output 750. Output 750 may, for example, be a user interface where the structured data may be rendered. However, output 750 can be other UI elements, storage, or a communications subsystem, among other options.

### Encoding and Decoding on a Server Device

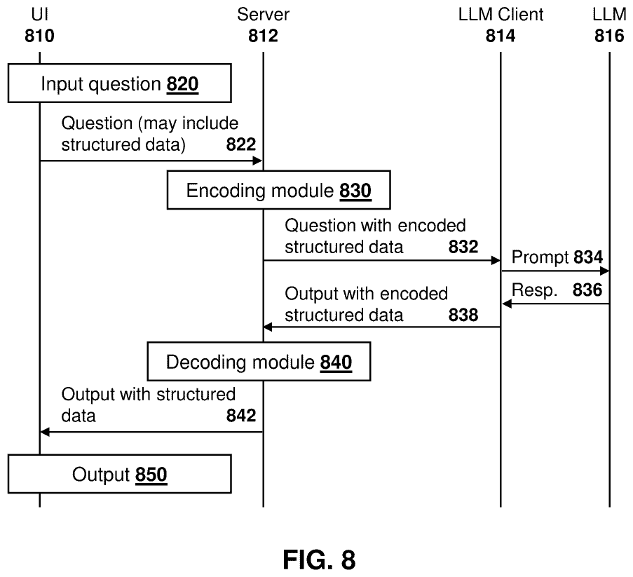

Reference is now made to FIG. 8, which shows the encoding and decoding modules at a server 812.

In the embodiment of FIG. 8, a client 810 may be a personal computer, tablet, smartphone, laptop, or other computer used by a client. In the situation where the structured data is a web page, client 810 may be a web client.

Client 810 may communicate with a server 812. For example, server 812 may be a web server in some cases. However, in other cases, server 812 may be a corporate server, a cloud server to provide services, among other options.

Server 812 may communicate with LLM client 814.

LLM client 814 is a piece of software directly making the calls to the LLM 816. Specifically, typically an LLM 816 will not be reachable except though an LLM client 814.

However, if the LLM 816 is directly reachable, then LLM client 814 is optional.

In the example of FIG. 8, a user may use client 810, for example using a user interface, to input a question at block 820.

In this case, the question may be provided to server 812 in message 822. Further, in some cases message 822 may include the structured data that is used with the question. However, this is optional, and in some cases server 812 may already have such structured data.

Server 812 may receive message 812 and may encode it. In this case, an encoding module 830 is part of server 812 and can be configured to intercept questions for an AI assistant. In this regard, encoding module 830 may use the process of FIG. 5 to encode the structured data into encoded structured data.

Server 812 may then forward the question with the encoded structured data in message 832 to the LLM client 814.

LLM client 814 may receive message 832 and may then create a prompt 834 to send to the LLM 816.

LLM 816 processes the question and the data in the prompt and provides a response 836 back to the LLM client 814.

LLM client 814 may then provide the output with the encoded structured data back to the server 812 in message 838.

Server 812, upon receiving message 838 may provide the message to the decoding module 840. The decoding module 840 may use the process of FIG. 6 to substitute the aliases with data elements to create structured data.

Server 812 may provide the output with the structured data back to the client 810 in message 842.

Such structured data that may then be provided to an output 850. Output 850 may, for example, be a user interface where the structured data may be rendered. However, output 850 can be other UI elements, storage, or a communications subsystem, among other options.

### Encoding and Decoding as Part of the LLM

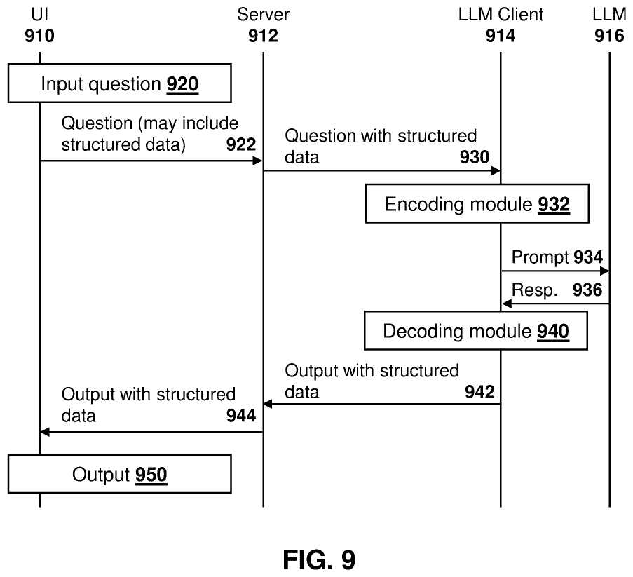

In a further embodiment, the encoding and decoding may be part of the LLM. Reference is now made to FIG. 9, which shows the encoding and decoding modules at a LLM client 914.

In the embodiment of FIG. 9, a client 910 may be a personal computer, tablet, smartphone, laptop, or other computer used by a client. In the situation where the structured data is a web page, client 910 may be a web client.

Client 910 may communicate with a server 912. For example, server 912 may be a web server in some cases. However, in other cases, server 912 may be a corporate server, a cloud server to provide services, among other options. In the embodiment of FIG. 9, server 912 is optional if client 910 can communicate directly with LLM client 914.

In other cases, server 912 may communicate with LLM client 914.

LLM client 914 is a piece of software directly making the calls to the LLM 916. Specifically, typically an LLM 916 will not be reachable except though an LLM client 914.

In the example of FIG. 9, a user may use client 910, for example using a user interface, to input a question at block 920.

In this case, the question may be provided to server 912 in message 922. Further, in some cases message 922 may include the structured data that is used with the question. However, this is optional, and in some cases server 912 may already have such structured data.

Server 912 may receive message 912 and may forward it to LLM client 914 in message 930. In some cases, message 930 may include the structured data. However, if LLM client 914 already has access to the structured data, then message 930 may, in some cases, omit the structured data.

LLM client 914, on receiving message 930, may encode the structured data. In this case, an encoding module 932 can be configured to intercept questions for an AI assistant. In this regard, encoding module 930 may use the process of FIG. 5 to encode the structured data into encoded structured data.

LLM client 914 may then create a prompt 934 to send to the LLM 916.

LLM 916 processes the question and the data in the prompt, and may provide a response 936 back to the LLM client 914.

LLM client, upon receiving response 936 may provide the message to the decoding module 940. The decoding module 940 may use the process of FIG. 6 to substitute the aliases with data elements to create structured data.

LLM client 914 may then provide the output with the structured data back to the server 912 in message 942.

Server 912 may provide the output with the structured data back to the client 910 in message 944.

Such structured data that may then be provided to an output 950. Output 950 may, for example, be a user interface where the structured data may be rendered. However, output 950 can be other UI elements, storage, or a communications subsystem, among other options.

Based on the above, structured data destined for an LLM may be encoded to substitute dense text with more token friendly text. Such encoded data may then be provided to the LLM, which may provide an output. The output can be decoded using mapping that was created during the encoding to create the structured data. For example, the output can be decoded back into the original markup language using a translation map. This ensures that the downstream actions, like changes to the website's appearance, can be executed faster, thereby enhancing user experience and reducing latency.

Another potential advantage of the embodiments herein may include its scalability. As the complexity and size of the page layout (or other structured data) increases, the benefits of using shorter, token-efficient identifiers become more apparent. Greater verbosity in the original document would lead to longer processing times, but with the embodiments herein, the performance of the AI assistant remains consistent, even with larger documents.

The encoding and decoding modules may be implemented on any server or computing device, and these may include the computing device described with regard to FIG. 2.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer method at a computing device comprising:
encoding structured data, the encoding comprising substituting one or more data elements within the structured data with corresponding one or more aliases, thereby producing encoded structured data, wherein the corresponding one or more aliases have a shorter tokenized representation than a tokenized representation of the one or more data elements;
providing the encoded structured data to a Large Language Model (LLM);
receiving an output from the LLM; and
decoding the output to substitute the corresponding one or more aliases with the one or more data elements.

2. The method of claim 1, wherein the encoding creates a mapping between the one or more data elements and the one or more aliases; and
wherein the decoding using the mapping to substitute the corresponding one or more aliases with the one or more data elements.

3. The method of claim 2, wherein the mapping uses at least one of a database and a look-up table.

4. The method of claim 2, wherein the mapping is static during a session with the LLM.

5. The method of claim 1, wherein the one or more data elements comprise element identifiers within the structured data.

6. The method of claim 1, wherein the corresponding one or more aliases are sequentially numbered.

7. The method of claim 1 wherein the one or more data elements comprise variables within the structured data.

8. The method of claim 1, wherein the computing device is one of a client device and a server device.

9. A computing device comprising:
a processor;
a memory; and
a communications subsystem,
wherein the computing device is provided with instruction code that, when processed by the processor, cause the computing device to:
encode structured data by substituting one or more data elements within the structured data with corresponding one or more aliases, thereby producing encoded structured data, wherein the corresponding one or more aliases have a shorter tokenized representation than a tokenized representation of the one or more data elements;
provide the encoded structured data to a Large Language Model (LLM);
receive an output from the LLM; and
decode the output to substitute the corresponding one or more aliases with the one or more data elements.

10. The computing device of claim 9, wherein the computing device is configured to encode by creating a mapping between the one or more data elements and the one or more aliases; and
wherein the computing device is configured to decode by using the mapping to substitute the corresponding one or more aliases with the one or more data elements.

11. The computing device of claim 10, wherein the mapping uses at least one of a database and a look-up table.

12. The computing device of claim 10, wherein the mapping is static during a session with the LLM.

13. The computing device of claim 9, wherein the one or more data elements comprise element identifiers within the structured data.

14. The computing device of claim 9, wherein the corresponding one or more aliases are sequentially numbered.

15. The computing device of claim 9, wherein the one or more data elements comprise variables within the structured data.

16. The computing device of claim 9, wherein the computing device is one of a client device and a server device.

17. A non-transitory computer readable medium for storing instruction code that, when processed by a processor of a computing device, cause the computing device to:
encode structured data by substituting one or more data elements within the structured data with corresponding one or more aliases, thereby producing encoded structured data, wherein the corresponding one or more aliases have a shorter tokenized representation than a tokenized representation of the one or more data elements;
provide the encoded structured data to a Large Language Model (LLM);
receive an output from the LLM; and
decode the output to substitute the corresponding one or more aliases with the one or more data elements.

18. The non-transitory computer readable medium of claim 17, wherein the instruction code is configured to cause the computing device to:
encode by creating a mapping between the one or more data elements and the one or more aliases; and
decode by using the mapping to substitute the corresponding one or more aliases with the one or more data elements.

19. The non-transitory computer readable medium of claim 18, wherein the mapping uses at least one of a database and a look-up table.

20. The non-transitory computer readable medium of claim 18, wherein the mapping is static during a session with the LLM.
